(19) United States
(12) Patent Application Publication
(10) Pub. No.: US 2026/0163308 A1
(43) Pub. Date: Jun. 11, 2026

(54) TERMINAL-EQUIPPED ELECTRIC WIRE

(71) Applicant: YAZAKI CORPORATION, Tokyo (JP)

(72) Inventors: Masanori Nakamura, Kakegawa-shi (JP); Takao Murakami, Kakegawa-shi (JP); Shinichi Kamura, Kakegawa-shi (JP)

(21) Appl. No.: 19/412,851

(22) Filed: Dec. 9, 2025

(30) Foreign Application Priority Data
Dec. 11, 2024 (JP) 2024-216119

(51) Int. Cl. H01R 13/66; B60L 53/16; B60L 53/18; B60L 53/60; G01K 1/14; G01K 1/16

(52) U.S. Cl. CPC H01R 13/6683; G01K 1/14; G01K 1/16; B60L 53/16; B60L 53/18; B60L 53/60; H01R 2201/26

(57) ABSTRACT

A terminal-equipped electric wire includes: an electric wire; a terminal fitting fixed to a conductor of the electric wire; a gel-like heat transfer member in surface contact with the terminal fitting; a sensor disposed on the heat transfer member and capable of determining the temperature of the terminal fitting; and a sensor fixing portion that is fixed to the terminal fitting by covering the sensor.

### BACKGROUND OF THE INVENTION

### Field of the Invention

An embodiment of the present invention relates to a terminal-equipped electric wire.

Priority is claimed on Japanese Patent Application No. 2024-216119 filed in Japan on Dec. 11, 2024, the content of which is incorporated herein by reference.

### Description of Related Art

As a terminal-equipped electric wire, for example, one disclosed in Patent Document 1 is known. In the terminal-equipped electric wire, a terminal fitting is attached to an end portion of the electric wire in order to charge a battery mounted on an electric vehicle or a hybrid vehicle. When the battery is charged by the terminal-equipped electric wire, a high current flows through the terminal-equipped electric wire, so that it is conceivable that the terminal fitting and the electric wire become hot. In order to avoid high temperatures of the terminal fitting and the electric wire, for example, a sensor is attached to the terminal fitting to determine the temperature of the terminal fitting.

In addition, Patent Document 2 discloses a terminal-equipped electric wire in which a sensor is attached to a terminal fitting via a thermal connection member. The thermal connection member is made of metal such as Cu. According to the terminal-equipped electric wire, the heat of the terminal fitting can be transmitted to the sensor by the thermal connection member.

### Prior Art Document

### Patent Document

Patent Document 1: Japanese Unexamined Patent Application, First Publication No. 2021-125339
Patent Document 2: Japanese Unexamined Patent Application, First Publication No. 2019-500733

### SUMMARY OF THE INVENTION

Here, in the terminal-equipped electric wire of Patent Document 2, for example, the thermal connection member is formed of metal such as Cu. Therefore, it is difficult for the terminal-equipped electric wire to bring the thermal connection member into contact with the outer periphery of the terminal, and it is difficult to improve the measurement accuracy of the sensor. As a countermeasure against this, it is conceivable to use a member having flexibility as the thermal connection member. However, it is difficult for the thermal connection member having flexibility to be held in a stable state on the outer periphery of the terminal, and even in this case, it is difficult to improve the measurement accuracy of the sensor.

One embodiment is to provide a terminal-equipped electric wire capable of enhancing measurement accuracy by a sensor with respect to a temperature of a terminal fitting.

A terminal-equipped electric wire according to one embodiment includes: an electric wire; a terminal fitting fixed to a conductor of the electric wire; a gel-like heat transfer member in surface contact with the terminal fitting; a sensor disposed on the heat transfer member and capable of determining the temperature of the terminal fitting; and a sensor fixing portion that is fixed to the terminal fitting by covering the sensor.

According to one embodiment, the measurement accuracy of the sensor with respect to the temperature of the terminal fitting can be enhanced.

### BRIEF DESCRIPTION OF THE DRAWINGS

FIG. 1 is a perspective view illustrating a terminal-equipped electric wire according to a first embodiment.

FIG. 2 is an exploded perspective view illustrating the terminal-equipped electric wire according to the first embodiment.

FIG. 3 is a perspective view illustrating a terminal fitting and an electric wire included in the terminal-equipped electric wire according to the first embodiment.

FIG. 4 is a cross-sectional view taken along line IV-IV in FIG. 1.

FIG. 5 is a cross-sectional view taken along line V-V in FIG. 1.

FIG. 6 is a cross-sectional view illustrating a terminal-equipped electric wire of a second embodiment.

### DETAILED DESCRIPTION OF THE INVENTION

Hereinafter, embodiments will be described with reference to the drawings. In the following description, constitutions having the same or similar functions are denoted by the same reference numbers. Redundant descriptions of these constitutions may be omitted. Note that the constitution described below does not limit the scope of the embodiment.

### First Embodiment

### <1. Terminal-Equipped Electric Wire>

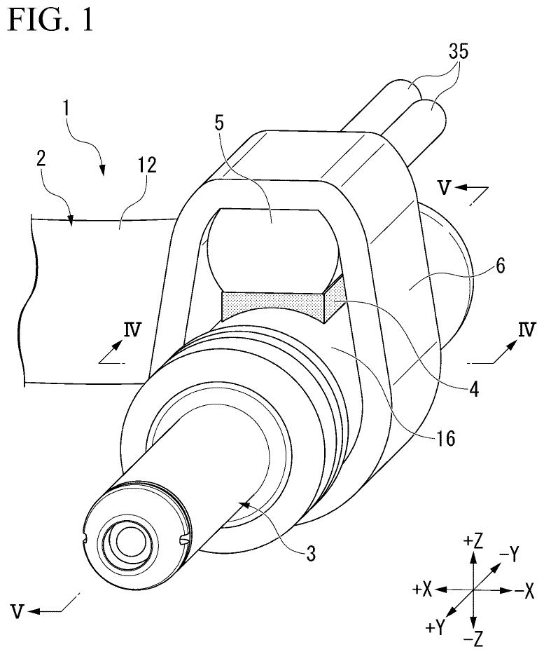

As illustrated in FIG. 1, a terminal-equipped electric wire 1 is used, for example, when charging a battery mounted on a vehicle. Specifically, the battery includes a charging connector. The charging connector includes, for example, a connection terminal for charging inside a plurality of terminal housing chambers (not illustrated). The terminal-equipped electric wire 1 is inserted into the terminal housing chamber and connected to the connection terminal when the battery is charged.

The battery is mounted on a vehicle (not illustrated) such as an electric vehicle (EV), a hybrid electric vehicle (HEV), or a plug-in hybrid electric vehicle (PHEV). In the first embodiment, an example in which the terminal-equipped electric wire 1 is connected to a charging connector of a battery mounted on a vehicle such as an EV, an HEV, or a PHEV will be described, but the terminal-equipped electric wire 1 may be applied to another device or the like.

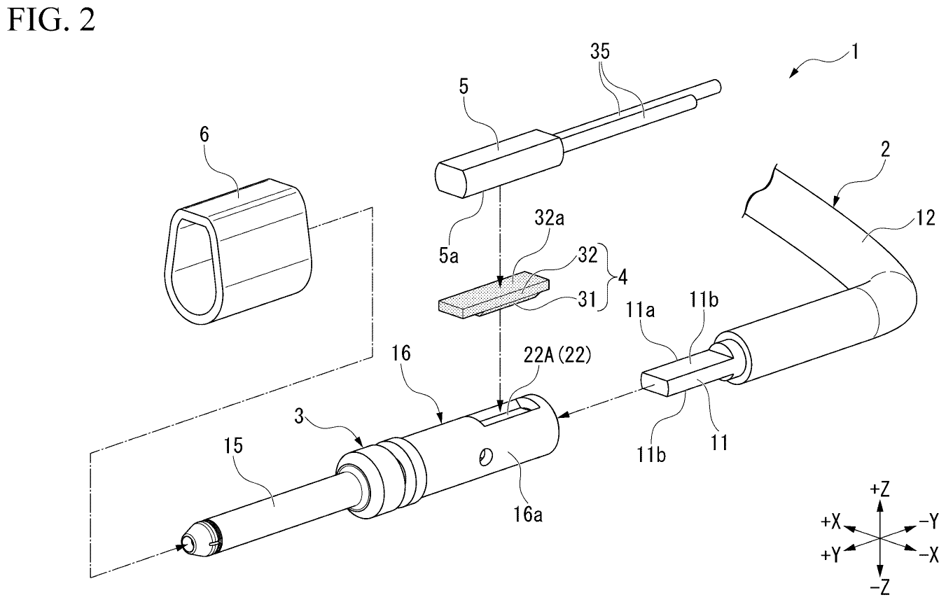

As illustrated in FIGS. 1 and 2, the terminal-equipped electric wire 1 includes, for example, an electric wire 2, a terminal fitting 3, a heat transfer member 4, a sensor 5, and a sensor fixing portion 6.

In the electric wire 2, a conductor 11 is covered with an insulating coating 12. A distal end portion 11a of the conductor 11 has a pair of step portions 11b. An electric wire connection portion 16 of the terminal fitting 3 is fixed to the pair of step portions 11b of the conductor 11. The heat transfer member 4 is in surface contact with the electric wire connection portion 16 of the terminal fitting 3. A recess portion 22A of the electric wire connection portion 16 of the terminal fitting 3 is filled with the heat transfer member 4. The heat transfer member 4 is a gel-like member, and has flexibility and adhesiveness. The sensor 5 is disposed on the heat transfer member 4 and can determine a temperature. The sensor fixing portion 6 collectively covers the terminal fitting 3, the heat transfer member 4, and the sensor 5 and fixes the sensor 5 and the heat transfer member 4 to the terminal fitting 3.

In the present disclosure, an X direction, a +X direction, a −X direction, a Y direction, a +Y direction, a −Y direction, a Z direction, a +Z direction, and a −Z direction are defined as follows.

The X direction is a direction orthogonal to the axial direction of the terminal fitting 3 and along the pair of step portions 11b of the conductor 11. The +X direction is a direction on the upper left side of the paper surface in the X direction. The −X direction is a direction on the lower right side of the paper surface. Hereinafter, the +X direction and the −X direction are simply referred to as “X direction” when they are not distinguished from each other.

The Y direction is an axial direction of the terminal fitting 3. The +Y direction is a direction opposite to the electric wire connection portion 16 in the terminal fitting 3 in the Y direction. The −Y direction is a direction toward the electric wire connection portion 16 in the terminal fitting 3 in the Y direction. Hereinafter, the +Y direction and the −Y direction are simply referred to as “Y direction” when they are not distinguished from each other.

The Z direction is a direction intersecting the X direction and the Y direction. The +Z direction is a direction on a side where the sensor 5 is disposed in the terminal fitting 3. The −Z direction is a direction opposite to the sensor 5 in the terminal fitting 3. Hereinafter, in a case where the +Z direction and the −Z direction are not distinguished, the directions are simply referred to as “Z direction”.

Hereinafter, the +X direction side may be referred to as “left”, the −X direction side may be referred to as “right”, the +Y direction may be referred to as “front”, and the −Y direction may be referred to as “rear”. In addition, the +Z direction side may be referred to as “upper”, and the −Z direction side may be referred to as “lower”. In addition, the axial direction of the terminal fitting 3 may be simply referred to as an “axial direction”. However, these expressions are expressions for convenience of description, and do not limit the attachment posture of the terminal-equipped electric wire 1.

### <2. Electric Wire>

The electric wire 2 includes the long conductor 11 and the insulating coating 12. As the conductor 11, for example, a wire material of a conductive metal containing copper or aluminum as a main component is used. In the first embodiment, for example, a copper alloy containing copper as a main component is used for the conductor 11. The conductor 11 can be, for example, a stranded wire having a plurality of strands or a single wire. The insulating coating 12 covers the periphery of the conductor 11 except for the distal end portion 11a of the conductor 11.

The distal end portion 11a of the conductor 11 protrudes from the insulating coating 12 and is connected to the terminal fitting 3. Specifically, the distal end portion 11a of the conductor 11 has the pair of step portions 11b. The pair of step portions 11b is formed along the axial direction on the surface (outer peripheral surface) of the distal end portion 11a, and is disposed at positions facing each other. In the pair of step portions 11b, for example, one step portion 11b is disposed above and the other step portion 11b is disposed below.

### <3. Terminal Fitting>

The terminal fitting 3 is a substantially columnar connection terminal (male terminal). The terminal fitting 3 is formed by, for example, cutting conductive metal. The terminal fitting 3 may be formed by press working (punching and bending) from a metal plate of one conductive metal (copper, copper alloy, or the like).

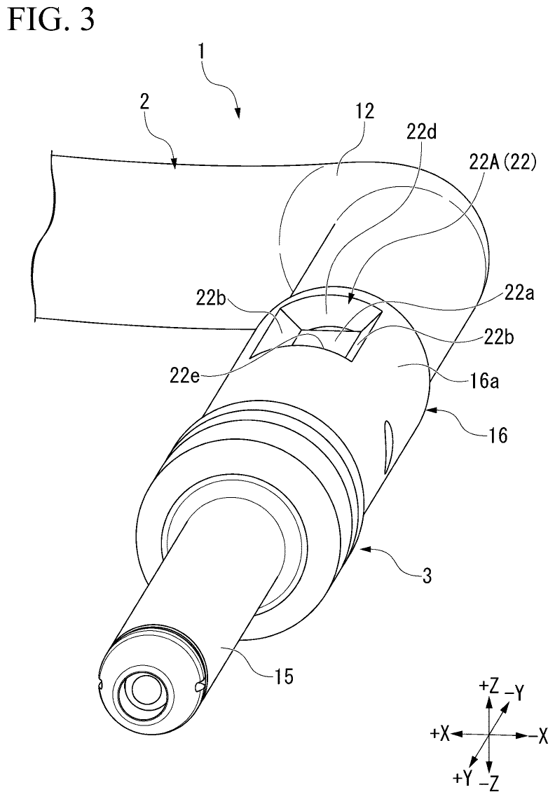

As illustrated in FIGS. 3 to 5, the terminal fitting 3 includes a terminal connection portion 15 and the electric wire connection portion 16. The terminal connection portion 15 is provided in the front half portion of the terminal fitting 3. The terminal connection portion 15 is formed in a columnar shape. The terminal connection portion 15 is connected to a connection terminal (female terminal) in a charging connector (not illustrated).

The electric wire connection portion 16 is provided in the rear half portion of the terminal fitting 3. The electric wire connection portion 16 is formed in a cylindrical shape. The electric wire connection portion 16 includes a conductor insertion hole 21 and a pair of recess portions 22. The conductor insertion hole 21 extends in the axial direction inside the electric wire connection portion 16 and has an opening portion 25 opened at the rear end. The conductor insertion hole 21 is formed such that the distal end portion 11a of the conductor 11 can be inserted from the opening portion 25.

The pair of recess portions 22 is disposed at positions facing each other on the surface (outer peripheral surface) 16a of the electric wire connection portion 16. The pair of recess portions 22 is formed to be recessed in a groove shape, for example, by caulking a surface 16a of the electric wire connection portion 16 radially inward. The pair of recess portions 22 is disposed so as to extend along the axial direction of the terminal fitting 3. In the pair of recess portions 22, for example, one recess portion 22 is disposed above and the other recess portion 22 is disposed below. The recess portion 22 has a bottom portion 22a, a pair of side walls 22b, a front wall 22c, a rear wall 22d, and an opening portion 22e.

The bottom portion 22a is formed flat along the left-right direction and the front-rear direction. The bottom portion 22a is disposed along the axial direction of the terminal fitting 3. The pair of side walls 22b extends obliquely so as to gradually expand from both sides of the bottom portion 22a to the surface 16a (that is, the opening portion 22e) in the left-right direction. The front wall 22c is formed continuously on the front sides of the pair of side walls 22b. For example, the front wall 22c is disposed so as to intersect with the axial direction (orthogonal in the first embodiment).

The rear wall 22d is formed continuously on the rear sides of the pair of side walls 22b. For example, the rear wall 22d is disposed so as to intersect with the axial direction (orthogonal in the first embodiment). The opening portion 22e is opened on the surface 16a of the electric wire connection portion 16.

The pair of recess portions 22 has a back surface 23. The back surfaces 23 of the pair of recess portions 22 protrude radially inward from an inner surface 21a of the conductor insertion hole 21 by forming the pair of recess portions 22 on the surface 16a of the electric wire connection portion 16. The pair of back surfaces 23 is formed at positions corresponding to the pair of recess portions 22 on the inner surface 21a of the conductor insertion hole 21. The pair of back surfaces 23 are surfaces crimped to the pair of step portions 11b in the distal end portion 11a of the conductor 11.

In other words, the pair of recess portions 22 can be crimped to the pair of step portions 11b. The distal end portion 11a of the conductor 11 is inserted into the conductor insertion hole 21 from the opening portion 25. The pair of step portions 11b is disposed inside the conductor insertion hole 21. The distal end portion 11a of the conductor 11 is fixed by the pair of recess portions 22 in a state of being inserted into the electric wire connection portion 16 by crimping the pair of step portions 11b by the pair of recess portions 22.

### <4. Heat Transfer Member>

The heat transfer member 4 is a gel-like member. The heat transfer member 4 is formed of, for example, a gel having excellent heat conductivity and further excellent flexibility, adhesiveness, or the like. The heat transfer member 4 includes a filling portion 31 and an exposed portion 32. The filling portion 31 and the exposed portion 32 are integrally formed. The filling portion 31 can fill an upper recess portion 22 of the pair of recess portions 22 in the electric wire connection portion 16. Hereinafter, the upper recess portion 22 filled with the filling portion 31 may be simply abbreviated as a “recess portion 22A”. The recess portion 22A is formed in a groove shape that can be filled with the filling portion 31. In the first embodiment, an example in which the recess portion 22A is formed by caulking the electric wire connection portion 16 radially inward will be described, but the present invention is not limited to this. The recess portion 22A may be formed in a groove shape by other processing.

For example, the surface of the filling portion 31 is disposed to be flush with the surface 16a of the electric wire connection portion 16 in a state where the recess portion 22A is filled. The surface of the filling portion 31 is exposed to the opening portion 22e of the recess portion 22A. The filling portion 31 is filled in a state of being in surface contact with and in close contact with the bottom portion 22a, the pair of side walls 22b, the front wall 22c, and the rear wall 22d of the recess portion 22A. That is, the filling portion 31 is filled in a state of being in close contact with the entire region of the recess portion 22A.

The exposed portion 32 is integrally formed on the surface of the filling portion 31. The exposed portion 32 protrudes outward in the radial direction of the electric wire connection portion 16 from the surface 16a of the electric wire connection portion 16. The exposed portion 32 is formed in, for example, a rectangular shape. The sensor 5 is disposed in close contact with a surface 32a of the exposed portion 32.

The heat transfer member 4 is filled with the filling portion 31 in a state of being in close contact with the entire region of the recess portion 22A, and the exposed portion 32 is disposed in a state of being in close contact with the sensor 5, whereby the heat of the electric wire connection portion 16 (that is, the terminal fitting 3) can be efficiently transferred to the sensor 5.

### <5. Sensor>

As illustrated in FIGS. 2, 4, and 5, the sensor 5 is, for example, a thermistor having a thermistor element (not illustrated) that determines temperature. The sensor 5 is formed in a substantially rectangular parallelepiped shape in which a thermistor element is covered with a resin. A lower surface 5a of the sensor 5 is disposed in surface contact with and in close contact with the surface 32a of the exposed portion 32. A pair of determination lines 35 connected to the thermistor element is led out from a rear end of the sensor 5. Note that the sensor 5 can also be, for example, a sensor that determines a state such as humidity or vibration.

### <6. Sensor Fixing Portion>

The sensor fixing portion 6 is, for example, a member formed in a pipe shape (tube shape). The sensor fixing portion 6 is made of various thermoplastic materials such as polyolefin, fluoropolymer (FEP, PTFE, Kynar, or the like), PVC, neoprene, silicone elastomer, and Viton. The sensor fixing portion 6 is, for example, a member that can be contracted by application of heat.

The sensor fixing portion 6 is contracted in a state of being in close contact with the outer shapes of the terminal fitting 3, the sensor 5, or the like by heat applied by, for example, a hot air gun or the like. Specifically, the sensor fixing portion 6 is formed in a tubular shape larger than an apparent outer shape of the electric wire connection portion 16, the heat transfer member 4, and the sensor 5 in the terminal fitting 3. The sensor fixing portion 6 is contracted smaller than the outer shape of the electric wire connection portion 16, the heat transfer member 4, and the sensor 5 when heat is applied thereto. The contracted sensor fixing portion 6 fixes the sensor 5 in a state of being in close contact with the exposed portion 32 in a state where the electric wire connection portion 16, the heat transfer member 4, and the sensor 5 are collectively covered.

### <7. Means for Assembling Terminal-Equipped Electric Wire>

A representative example of assembling the terminal-equipped electric wire 1 will be described with reference to FIGS. 2, 4, and 5. Note that the assembly procedure can be arbitrarily selected.

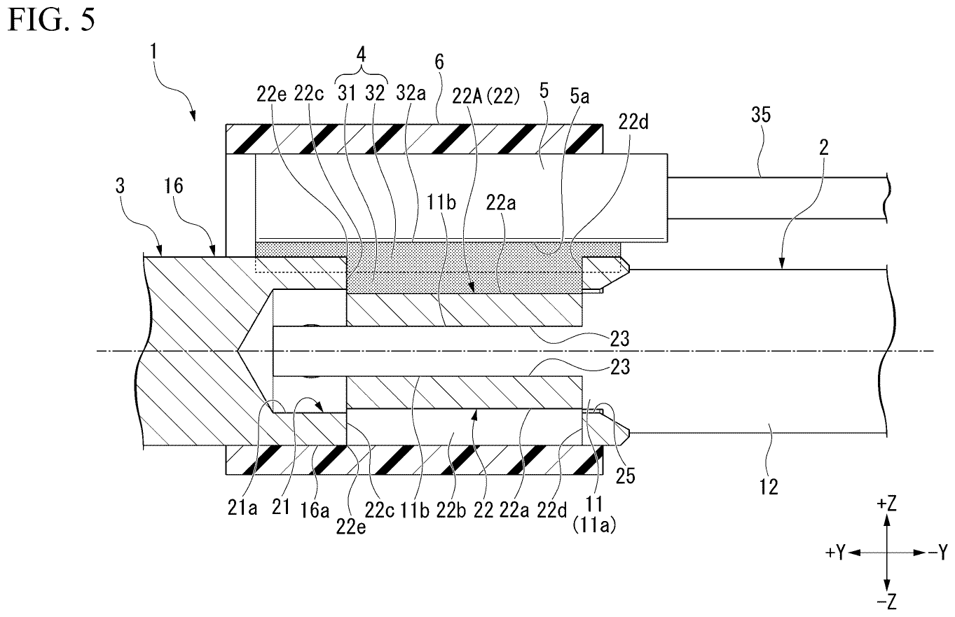

As illustrated in FIGS. 2 and 5, first, the distal end portion 11a of the conductor 11 in the electric wire 2 is inserted into the conductor insertion hole 21 at the electric wire connection portion 16 of the terminal fitting 3 from the opening portion 25. A distal end portion 11a of the conductor 11 has a pair of step portions 11b. The pair of step portions 11b is disposed inside the conductor insertion hole 21.

Next, the electric wire connection portion 16 of the terminal fitting 3 is caulked radially inward. A pair of recess portions 22 is formed on the surface 16a of the electric wire connection portion 16. By forming the pair of recess portions 22, the back surfaces 23 of the pair of recess portions 22 protrude from the inner surface 21a of the conductor insertion hole 21 toward the inside of the conductor insertion hole 21. The pair of back surfaces 23 presses the pair of step portions 11b. That is, the pair of recess portions 22 presses the pair of step portions 11b.

The pair of step portions 11b is fixed to the pair of recess portions 22 by being pressed by the pair of recess portions 22. By fixing the pair of step portions 11b to the pair of recess portions 22, the distal end portion 11a of the conductor 11 is fixed inside the conductor insertion hole 21. That is, the distal end portion 11a of the conductor 11 is fixed to the electric wire connection portion 16 of the terminal fitting 3.

As illustrated in FIGS. 2, 4, and 5, in a state where the distal end portion 11a of the conductor 11 is fixed to the electric wire connection portion 16 of the terminal fitting 3, the recess portion 22A of the electric wire connection portion 16 is filled with the filling portion 31 of the heat transfer member 4. Next, the sensor 5 is disposed on the exposed portion 32 of the heat transfer member 4. Then, the sensor fixing portion 6 is fitted into the electric wire connection portion 16, the heat transfer member 4, and the sensor 5 from the terminal connection portion 15 side of the terminal fitting 3.

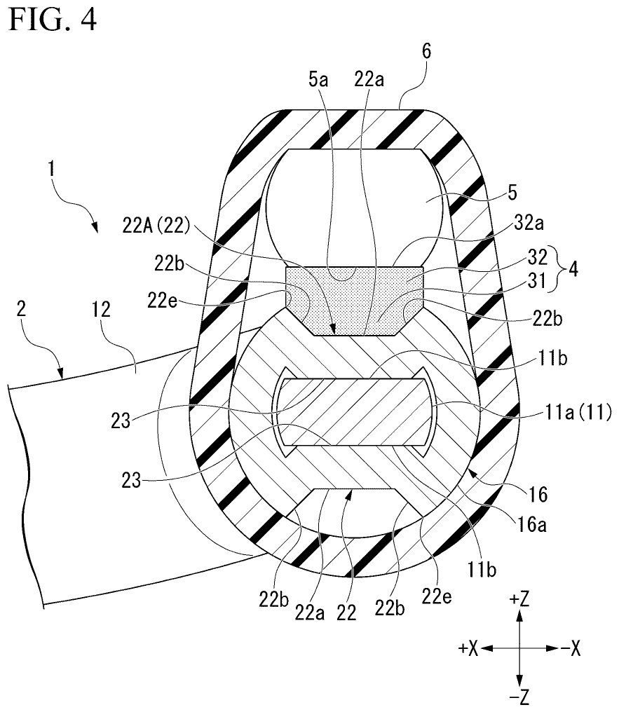

As illustrated in FIGS. 4 and 5, heat is applied to the sensor fixing portion 6 in a state where the sensor fixing portion 6 is fitted into the electric wire connection portion 16, the heat transfer member 4, and the sensor 5. When heat is applied to the sensor fixing portion 6, the sensor fixing portion 6 contracts. By covering the sensor 5 with the contracted sensor fixing portion 6, the sensor 5 is fixed in a state of being in close contact with the heat transfer member 4. By fixing the sensor 5 to the heat transfer member 4 by the sensor fixing portion 6, the assembling work of the terminal-equipped electric wire 1 is completed.

### <8. Operation and Effects of the Invention>

According to the terminal-equipped electric wire 1 of the first embodiment, as illustrated in FIGS. 2 and 4, the terminal fitting 3 has the recess portion 22A opened to the surface 16a of the electric wire connection portion 16. The recess portion 22A is filled with the gel-like heat transfer member 4. The gel-like heat transfer member 4 has, for example, flexibility and adhesiveness. The gel-like heat transfer member 4 is filled in a state of being in close contact with the recess portion 22A, and is further in close contact with the sensor 5. With such a constitution, the heat transfer member 4 can enhance heat transfer efficiency of transferring the heat of the terminal fitting 3 to the sensor 5. Therefore, the measurement accuracy (that is, temperature measurement performance) of the sensor 5 with respect to the temperature of the terminal fitting 3 can be enhanced.

In addition, as illustrated in FIGS. 2 and 5, the recess portion 22A is disposed along the axial direction of the terminal fitting 3. The sensor 5 is disposed along the heat transfer member 4 filled in the recess portion 22A. With such a constitution, the heat transfer member 4 can further enhance heat transfer efficiency of transferring the heat of the terminal fitting 3 to the sensor 5.

Further, as illustrated in FIG. 4, the recess portion 22A has the bottom portion 22a and the pair of side walls 22b. The pair of side walls 22b extends obliquely so as to gradually spread from both sides of the bottom portion 22a to the surface 16a of the electric wire connection portion 16. With such a constitution, the gel-like heat transfer member can be filled in a state of being more closely attached along the bottom portion 22a and the pair of side walls 22b in the recess portion 22A.

In addition, as illustrated in FIGS. 4 and 5, the recess portion 22A is crimped to the step portion 11b of the distal end portion 11a of the conductor 11. The terminal fitting 3 is fixed to the step portion 11b of the distal end portion 11a by the recess portion 22A. The recess portion 22A has a function of fixing the terminal fitting 3 to the conductor 11 and a function of receiving the heat transfer member 4. With such a constitution, the terminal fitting 3 does not need to individually have a function of being fixed to the conductor 11 and a function of receiving the heat transfer member 4, and the constitution can be simplified.

### Second Embodiment

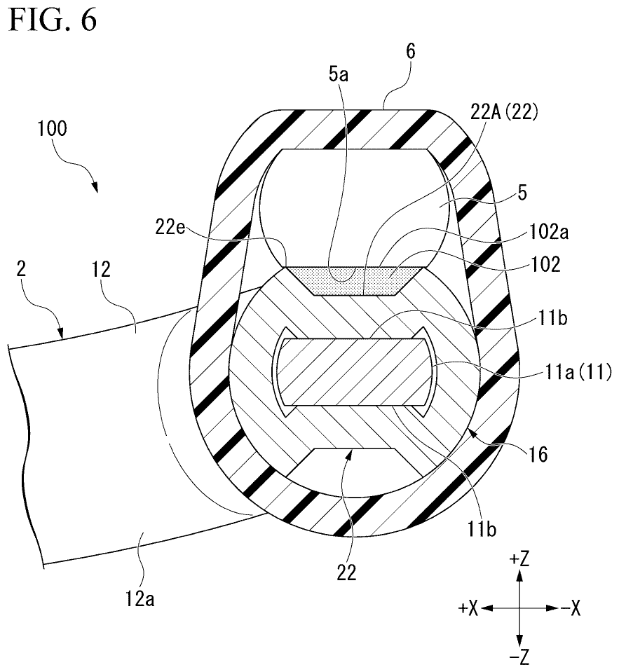

Next, a second embodiment will be described with reference to FIG. 6. In the second embodiment, the same or similar members as the constitution members of the first embodiment are denoted by the same reference numbers, and detailed description thereof will be omitted.

As illustrated in FIG. 6, a terminal-equipped electric wire 100 is obtained by replacing the heat transfer member 4 of the first embodiment with a heat transfer member 102. Other constitutions of the terminal-equipped electric wire 100 are similar to the constitutions of the heat transfer member 4 of the first embodiment.

A recess portion 22A is filled with the heat transfer member 102. That is, the heat transfer member 102 is a member similar to the filling portion 31 of the first embodiment. The heat transfer member 102 is in surface contact with an electric wire connection portion 16 of a terminal fitting 3. Similarly to the filling portion 31 of the first embodiment, the heat transfer member 102 is filled in a state of being in close contact with the entire region of a recess portion 22A. The heat transfer member 102 has a surface 102a exposed to an opening portion 22e of the recess portion 22A. For example, a lower surface 5a of a sensor 5 is disposed in close contact with the surface 102a of the heat transfer member 102.

The heat transfer member 102 is filled in a state of being in close contact with the entire region of the recess portion 22A, and is disposed in a state where the surface 102a is in close contact with the sensor 5, whereby the heat of the electric wire connection portion 16 (that is, the terminal fitting 3) can be efficiently transferred to the sensor 5.

In addition, the lower surface 5a of the sensor 5 can close the opening portion 22e of the recess portion 22A, for example, in a state of being disposed on the surface 102a of the heat transfer member 102. The lower surface 5a of the sensor 5 is disposed on the surface 16a of the electric wire connection portion 16 so as to close the opening portion 22e of the recess portion 22A. With such a constitution, in the recess portion 22A, an opening portion 22e is closed by a lower surface 5a of the sensor 5 in a state where the heat transfer member 102 is filled.

According to the terminal-equipped electric wire 100 of the second embodiment, as illustrated in FIG. 6, the opening portion 22e of the recess portion 22A is closed by the sensor 5 in a state where the heat transfer member 102 is filled. With such a constitution, in the terminal-equipped electric wire 100, the gel-like heat transfer member 102 filled in the recess portion 22A can be suppressed from flowing out from the opening portion 22e, and the heat transfer efficiency of the heat transfer member 102 can be further enhanced.

Furthermore, according to the terminal-equipped electric wire 100 of the second embodiment, it is possible to obtain the same operation and effect as those of the terminal-equipped electric wire 1 of the first embodiment.

In each of the above embodiments, the recess portion 22A of the terminal fitting 3 is filled with the heat transfer members 4 and 102. However, the heat transfer member 4 may be constituted in any manner as long as the heat transfer member 4 can be brought into surface contact with the terminal fitting 3. As a modification, the heat transfer members 4 and 102 may be brought into surface contact with a peripheral surface of a cylindrical terminal fitting such as a round terminal without the recess portion 22A. Also with such a constitution, the heat transfer members 4 and 102 can enhance heat transfer efficiency of transferring the heat of the terminal fitting 3 to the sensor 5.

Several embodiments and modification examples have been described above. However, the embodiments and the modification examples are not limited to the examples described above. For example, a plurality of embodiments may be implemented in combination with each other. The above-described embodiments can be implemented in various other forms, and various additions, omissions, substitutions, and other modifications can be made without departing from the scope of the present disclosure.

### REFERENCE SIGNS LIST

1, 100 Terminal-equipped electric wire
2 Electric wire
3 Terminal fitting
4, 102 Heat transfer member
5 Sensor
6 Sensor fixing portion
11 Conductor
16 Electric wire connection portion
16a Surface of electric wire connection portion
22, 22A Recess portion
22a Bottom portion
22b Pair of side walls
22e Opening portion
23 Back surface (surface crimped)

What is claimed is:

1. A terminal-equipped electric wire comprising:
an electric wire;
a terminal fitting fixed to a conductor of the electric wire;
a gel-like heat transfer member in surface contact with the terminal fitting;
a sensor disposed on the heat transfer member and capable of determining a temperature of the terminal fitting; and
a sensor fixing portion that is fixed to the terminal fitting by covering the sensor.

2. The terminal-equipped electric wire according to claim 1, wherein
the terminal fitting includes a recess portion opened to a surface, and
the heat transfer member is filled in the recess portion.

3. The terminal-equipped electric wire according to claim 2, wherein
the recess portion is disposed along an axial direction of the terminal fitting.

4. The terminal-equipped electric wire according to claim 2, wherein
the recess portion includes
a bottom portion, and
a pair of side walls extending obliquely so as to gradually spread from both sides of the bottom portion to the surface.

5. The terminal-equipped electric wire according to claim 2, wherein
the recess portion has a surface crimped to the conductor.

6. The terminal-equipped electric wire according to claim 2, wherein
the recess portion includes an opening portion closed by the sensor in a state where the heat transfer member is filled.
